(19) United States
(12) Patent Application Publication
(10) Pub. No.: US 2005/0154623 A1
(43) Pub. Date: Jul. 14, 2005

(54) Software toolbox supported procedure for online/offline simulation of company internal logistic processes (like arrival, warehousing, picking, shipping, production of goods) with integrated interfaces where the potential processes are manually and/or technically supported by manpower, fork lift trucks, various kinds of material flow, handling or storage systems to optimize logistic systems, to make their success and logistic projects calculable

(76) Inventor: Katrin Grienitz, Santa Barbara, CA (US)

Correspondence Address: Katrin Grienitz, 3463 State Street # 284, Santa Barbara, CA, 93105, US

(21) Appl. No.: 10/753,688

(22) Filed: Jan. 9, 2004

(51) Int. Cl. G06F 17/60

(52) U.S. Cl. 705/7

(57) ABSTRACT

Integrated simulation procedure and software toolbox for material handling processes and systems including flexible integrated online interfaces.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

The application package includes two CD-Rs with the complete source code and an executable program of the software toolbox, named GloSim. You will find a “readme.txt” file in the root path how to quick start the program.

Total number of compact disc: 2 (duplicates)

CD contents:

```
[Root]
readme.txt
  rrc
    GloSim
      bins
        WGLOSIM.EXE
        TRACE.DLL
        BC450RTL.DLL
        LANGMESS.TXT
      source
        sim
          [Source files]
        win
          [Source files]
      models ...
    Trace
      [Source files]
```

### BACKGROUND OF INVENTION

### FIELD OF ENDEAVOR

Make online simulation of company internal logistic systems and processes ready to use on the market; includes the creation of the right procedure and the appropriate software tool.

For the control of manual and especially for the control of automatic systems, there are a lot of computer levels that take care of the system control from incoming orders via material handling up to the invoice printing. These systems are often quite complex. Different suppliers have to be linked smoothly into a system. The level of investment is usually extremely high for the customers; the time frame for implementation and start up is narrow.

To control such a complex construction, there are interfaces between the single systems. The interfaces are mainly defined by the interface description in the requirement statements.

The former interfaces of mainframe computers were text file-oriented, and the interfaces close to machine language were more serial oriented. The development of Ethernet TCP/IP Socket Communication became a technical standard covering all levels. This technique is working on almost all common operating systems and is supported by a lot of automatic control suppliers.

While the technical standardization continued; the one from the point of view of content stayed supplier specific. The definition of transferred data is usually depending on the participants of the project within the conversations about the requirement statements.

In summary, one can say that despite of the technical standards to transfer data; the transfer of data within a single system is still specific.

To test the different systems during development and before implementation, you can use simulation systems. These simulation systems replace the specific communication partners based on the requirement statements.

The claimed invention opens a simple procedure with tool support to use online simulation for company internal logistic processes and systems. Old fashioned systems have just offline capability or are not able to implement flexible online interfaces in an economic useful way.

The applicability of the claimed invention (procedure and software tool box) was already successfully tested as a pilot system within a factory storage test environment.

### BRIEF SUMMARY OF THE INVENTION

The invention is the software toolbox supported procedure for online/offline simulation of company internal logistic processes.

The new procedure is the combination of the creation of the model, the offline check, the simple connection with other interface partners and the support of the design, pre starting, testing, optimization and maintenance work.

The software toolbox includes a set of standard objects with their interfaces which can be very fast created, parameterized and linked to complex models, usually done within 2 to 3 hours for complex systems (comparable standard tools need a minimum of 3 weeks.)

The online simulation is based on the toolbox integrated online interfaces. The simple usage of these interfaces is a substantial part of the invented process/procedure.

The offline simulation is the preliminary stage of the online simulation. It is usable to design/redesign/check logistic systems.

The potential company internal processes are e.g. the arrival, warehousing, picking, shipping, production of goods. These processes can be manually and/or technically supported. Manually means with direct manpower. Technically means with fork lift trucks, various kinds of material flow systems, material handling systems and/or storage systems.

Object of the invention is the support of different groups of customers not depending on a certain branch of industry to optimize their logistic systems, to make their success and logistic projects calculable.

### BRIEF DESCRIPTION OF THE SEVERAL VIEWS OF THE DRAWING

Not Applicable

### DETAILED DESCRIPTION OF THE INVENTION

Overview of potential application fields of the invention (not be entitled to completeness):

Overview

Phase
New, planned system
System development
Running system

Operation
Manual (manpower)
(Fully) automated
Mixed (semiautomatic)

Types
Manpower
   Radio frequency terminals
   Pick-by-light-, pick-to-light-systems
Conveyor techniques
   Belts
   Roles
   Chains
   Slides
   Ramps
   Tilt-tray sorter
Single place techniques
   Forklift trucks
   Driverless trucks
   Chain elements
   Roll elements
   Automatic guided vehicle system
Shelf techniques
   Shelves
   Cranes
   Bridges
Rail systems
   Endless chains
   Power & free
   Rail car unit

Application fields
Offer support
Design
Detailed design
List of components
Optimization
Set into work support
Online/offline test
Online/offline proof of target performance
Online acceptance test
Online/offline daily workload optimization
Online maintenance support
Online training

User
Owner of a logistic system
Planner/integrator of logistic systems
Supplier of any kind for logistic system components

The invention is the software toolbox supported procedure for online and offline simulation of company internal logistic systems and processes.

The new procedure is the combination of the creation of the logistic model, the offline check of the model and the system, the simple connection with other interface partners to replace the real environment with the connected model and the support of the design, pre starting, testing, optimization and maintenance work.

The model shows the behavior of the logistic system of a plan, factory, warehouse, assembly line etc. or parts of it. Within the tool a model can be saved in XML format to make data transfer easy. Different projects with their worksheets can be loaded in the tool at the same time. So this way it is possible to copy and paste prepared standard model parts from one sheet to another; interfaces can be copied in the same way, too.

The software toolbox includes a set of standard objects with their interfaces which can be very fast created, parameterized and linked to complex system. These objects can be selected with the mouse via menu item or button and set on a worksheet. The objects can be linked automatically while creation, or later manually. It is possible to check objects via mouse double click and to open different dialogs for parameterization.

The software toolbox is multilingual. Different languages can be selected via menu. The source is stored in a simple text file and can be simple enlarged by more languages. All menu items, button text, dialog items, selection boxes, etc. are supported by the selected language. This feature makes the tool ready for international projects; globally usable.

The software toolbox is easy to learn and simple to use. There is no need for software specialists. The tool is applicable for different project phases (design, calculation, offer, software development and test of interface partners, test, optimization, maintenance).

The online simulation is based on the toolbox integrated online interfaces. The simple and easy usage of these interfaces is a substantial part of the invented process/procedure. It is possible to replace the logistics (real technical equipment) by the connected PC model. For the other control levels like warehouse management systems (WMS) or material flow systems (MFS), there is no difference in usage/handling of the simulation. These systems work the same way as they would with the original logistic system. This fact opens up a variety of possibilities. Now, it is possible to test systems which are in planning or developing status. It is possible to check other control levels like warehouse management software or material flow software within normal office time. There is no need to stress the real logistic system in non-production time (nights, weekends, holidays, vacation time) with a lot of additional effort in time and great expense. The owner of the logistic system can train the staff during office time, too. The new economic opportunities are based on the possibility of the fast model design and the already integrated online interfaces.

The online interfaces are mainly based on TCP/IP socket communication via Ethernet. The interfaces can be created per drag & drop, and are configured very easily. Different environments with different Ethernet addresses and socket ports are available in the same model. Different data telegram formats, header and tail formats are usable. Links between the model and the interfaces are simple supported by dialogs. Especially this simple use of online interfaces embedded in the developing and test process makes online simulation ready to use on the market.

The offline simulation is the preliminary stage of the online simulation. It is usable to design/redesign/check logistic systems. Data creation happens internally or via loading of external text files, table sheet files or database files. With the import of external data different scenarios can be tested, too.

The potential company internal processes are the arrival, warehousing, picking, replenishment, shipping, production of goods. These processes can be manually and/or technically supported.

Manually support means with direct manpower. For instance, the pick orders are transferred via portable radio frequency terminals or via printed lists. Picking can be supported by Pick-By-Light- and/or Pick-To-Light-Systems. The actions of the manpower have to be simulated.

Technically means with fork lift trucks, various kinds of material flow systems, material handling systems and/or storage systems, like conveyor belt, automatic cranes for shelves, electric suspension track, power & free, endless chain with loading frames, automatic guided vehicles. All these systems are a combined technique with a separated controller or separated systems by themselves. There are separate interfaces to control them. The appropriate controllers are the interface partners which have to be simulated.

The object of the invention is the support of different groups of customers to optimize their logistic systems, to make their success and logistic projects calculable. It is not depending on a certain branch of industry, a country and/or a language. This new procedure with the software toolbox allows every planner, supplier or user of such kind of company internal logistic systems to maximize their efficiency on the specific level.
sample case 1: Situation: a new warehouse and distribution centre of a food company is planned on the green meadow; Problem: the time frame to start the production is very short; the purchase department want to safe money; the project manager want to ensure the start date 100%; Solution with the help of the claimed invention: a planner designs some different optional layouts with different techniques→creation of different models with software toolbox GloSim without IT specialist in a very short time→test models with offline mode; load data (different kind of food entry/shipping) directly from MS Excel sheet→customer agrees to the final design solution→planner starts an invitation to bid procedure; the offers from the suppliers are based on the final simulation model→customer/planner signs contract with supplier→supplier develops control software (warehouse management/material flow)→customer/planner checks delivery milestones of software components/modules directly online without the real logistic system→ready for start!

sample case 2: Situation: a 5 year old automated pallet system needs to increase its capacity because the good development of the company; Problem: there is no chance to stop the system because of customer's running business; necessary extensions have to be limited as much as possible; Solution with the help of the claimed invention: create a simulation model which reflects the current pallet system→play different scenarios to find a good solution to increase the throughput of the system (perhaps some new components or some layout changes)→test models with offline mode; load data (different kind of food entry/shipping) directly from MS Access database→finalize solution→make changes in the control software (warehouse management/material flow)→check new functionality of software components/modules directly online without the real logistic system→ready to switch!

sample case 3: Situation: Owner/management of an enterprise likes to train new short term staff periodically on the terminal software for the picking station; Problem: the picking station runs 24 hours in production; Solution with the help of the claimed invention: create a simulation model which reflect the behavior of the picking station→create test environments for the control system (with dialogs/screens)=interface partner→feed test system with playing data→connect test system to the GloSim PC model→train staff in the office at the test screens of the controlling software during standard office time!

WHAT IS REALLY NEW IN THIS CLAIMED INVENTION? It makes online simulation economically usable in new logistic market segments by reducing effort to create flexible interfaces embedded within a simple, easy to handle simulation tool, which fits the expectations of potential users. All the other online simulations use open programmable interfaces that require extra IT staff, higher expenses (time, personal, costs, etc.) programming them. This is not necessary any more with the claimed invention because of the already integrated, easy to parameterize interfaces (as described above).

1) a software toolbox supported procedure for online/offline simulation of company internal logistic processes (material handling like arrival, warehousing, picking, shipping, replenishment, production of goods) with integrated interfaces where the potential processes are manually and/or technically supported by manpower, fork lift trucks, various kinds of material flow, handling or storage systems to optimize logistic systems, to make their success and logistic projects calculable.

2) the software toolbox named GloSim which supports the above mentioned procedure.
